(19) United States
(12) Patent Application Publication
(10) Pub. No.: US 2024/0222738 A1
(43) Pub. Date: Jul. 4, 2024

(54) CHILLER OPERATION SYSTEM FOR ESS BATTERIES AND OPERATING METHOD THEREOF

(71) Applicant: HanJungNCS.CO., LTD, Yeongcheon-si (KR)

(72) Inventors: Gi Bum PARK, Seongnam-si (KR); Hyung Kyun SHIN, Gyeongsan-si (KR); Hwan Sik KIM, Yeongcheon-si (KR); Hwan Seob KIM, Daegu (KR)

(73) Assignee: HanJungNCS.CO., LTD, Yeongcheon-si (KR)

(21) Appl. No.: 18/585,888

(22) Filed: Feb. 23, 2024

(30) Foreign Application Priority Data
Dec. 30, 2022 (KR) 10-2022-0190319

(51) Int. Cl. H01M 10/633; H01M 10/48; H01M 10/613; H01M 10/6556; H01M 10/663

(52) U.S. Cl. CPC H01M 10/633; H01M 10/486; H01M 10/613; H01M 10/663; H01M 10/6556

(57) ABSTRACT

Proposed are a chiller operation system for ESS batteries and an operating method thereof. The system includes an ESS battery, a battery control unit that controls charging and discharging of the ESS battery, a chiller unit that cools the ESS battery according to a cooling control signal during charging and discharging of the ESS battery, an environmental sensor that measures detected temperature and detected humidity in a condensation occurrence area, a cooling control unit that performs heat management by providing the cooling control signal, calculates the dew point temperature using the detected temperature and the detected humidity, and provides a dehumidification control signal when condensation is predicted, and an air conditioning unit that operates in dehumidifying operation mode for the ESS battery according to the dehumidification control signal.

### CROSS REFERENCE TO RELATED APPLICATION

The present application claims priority to Korean Patent Application No. 10-2022-0190319, filed Dec. 30, 2022, the entire contents of which is incorporated herein for all purposes by this reference.

### BACKGROUND OF THE INVENTION

### Field of the Invention

The present disclosure relates to a chiller operation system for ESS batteries and an operating method thereof, which prevent condensation in ESS batteries and allow active maintenance of the ESS batteries by measuring detected temperature and detected humidity in an area where condensation occurs using an environmental sensor installed on the outside of an ESS battery, calculating, by a cooling control unit, the dew point temperature using the detected temperature and detected humidity, and providing a dehumidification control signal when condensation is predicted to occur based on the calculated dew point temperature, thereby causing an air conditioning unit to operate in dehumidifying operation mode for the ESS battery.

### Description of the Related Art

As is well known, ESS (energy storage system) batteries that can be charged and discharged when applied to eco-friendly vehicles, such as electric vehicles and hybrid electric vehicles, requires a system to manage the temperature of the battery in order to maintain optimal performance and efficiency by maintaining a target temperature (for example, for lithium-ion batteries, the target temperature is 20-30° C.) independent of the surrounding environment.

Such a system plays a role in delaying the temperature rise of ESS batteries when battery modules made up of an array of battery cells generate heat during charging and discharging of the ESS batteries, thereby ensuring stable charging and discharging of the ESS batteries.

However, a conventional system that manages the temperature of ESS batteries simply performs the role of maintaining a target temperature and does not manage the heat produced by the ESS batteries through active cooling control according to the charging and discharging environment of the ESS batteries, resulting in insufficient ESS battery heat management and reduced ESS battery charging efficiency.

### Document of Related Art

(Patent Document 1) Korean Patent Application Publication No. 10-2020-0009566 (Published Jan. 30, 2020)

### SUMMARY OF THE INVENTION

Accordingly, the present disclosure has been made keeping in mind the above problems occurring in the related art, and the present disclosure is intended to provide a chiller operation system for ESS batteries and an operating method thereof, which prevent condensation in ESS batteries and allow active maintenance of the ESS batteries by measuring detected temperature and detected humidity in an area where condensation occurs using an environmental sensor installed on the outside of an ESS battery, calculating, by a cooling control unit, the dew point temperature using the detected temperature and detected humidity, and providing a dehumidification control signal when condensation is predicted to occur based on the calculated dew point temperature, thereby causing an air conditioning unit to operate in dehumidifying operation mode for the ESS battery.

The objectives of the present disclosure are not limited to those mentioned above, and other objectives not mentioned will be clearly understood by those skilled in the art from the description below.

In order to achieve the above objective, according to an aspect of the present disclosure, there may be provided a chiller operation system for ESS batteries, the system including: an ESS battery; a battery control unit configured to control charging and discharging of the ESS battery; a chiller unit configured to cool the ESS battery according to a cooling control signal during charging and discharging of the ESS battery; an environmental sensor provided outside the ESS battery to measure detected temperature and detected humidity in a condensation occurrence area; a cooling control unit configured to communicate with the battery control unit, perform heat management by providing the cooling control signal during charging and discharging of the ESS battery, calculate dew point temperature using the detected temperature and the detected humidity, and provide a dehumidification control signal when condensation is predicted to occur on the basis of the calculated dew point temperature; and an air conditioning unit configured to operate in dehumidifying operation mode for the ESS battery according to the dehumidification control signal.

In addition, according to an aspect of the present disclosure, the cooling control unit may calculate the dew point temperature using Magnus formula.

In addition, according to an aspect of the present disclosure, while the air conditioning unit is operating in the dehumidifying operation mode, the cooling control unit may check whether a probability of condensation occurring within a preset first time is less than a preset condensation occurrence standard value and may provide a temperature adjustment signal to the chiller unit to adjust chiller outlet water temperature when the probability is greater than the preset condensation occurrence standard value.

In addition, according to an aspect of the present disclosure, while the chiller unit is operating with the chiller outlet water temperature adjusted, the cooling control unit may check whether a probability of condensation occurring within a preset second time has reached a level below the preset condensation occurrence standard value, and may output an alarm when the probability is greater than the preset condensation occurrence standard value.

According to another aspect of the present disclosure, there may be provided an operating method of a chiller operation system for ESS batteries, the method including: measuring detected temperature and detected humidity in a condensation occurrence area using an environmental sensor provided outside an ESS battery; calculating, by a cooling control unit, dew point temperature using the detected temperature and the detected humidity; checking, by the cooling control unit, whether condensation is predicted on the basis of the calculated dew point temperature; providing, by the cooling control unit, a dehumidification control signal when the condensation is predicted to occur; and operating an air conditioning unit in dehumidifying operation mode for the ESS battery according to the dehumidification control signal provided from the cooling control unit.

In addition, according to another aspect of the present disclosure, in the calculating dew point temperature, the dew point temperature may be calculated using Magnus formula.

In addition, according to another aspect of the present disclosure, the method may further include: checking, by the cooling control unit, whether a probability of condensation occurring within a preset first time is less than a preset condensation occurrence standard value while the air conditioning unit is operating in the dehumidifying operation mode; and providing, by the cooling control unit, a temperature adjustment signal to the chiller unit to adjust chiller outlet water temperature when the probability is greater than the preset condensation occurrence standard value.

In addition, according to another aspect of the present disclosure, the method may further include: checking, by the cooling control unit, whether a probability of condensation occurring within a preset second time has reached a level below the preset condensation occurrence standard value while the chiller unit is operating with the chiller outlet water temperature adjusted; and outputting an alarm when the probability is greater than the preset condensation occurrence standard value.

According to the present disclosure, condensation in ESS batteries can be prevented and active maintenance of the ESS batteries can be possible by measuring detected temperature and detected humidity in an area where condensation occurs using an environmental sensor installed on the outside of an ESS battery, calculating, by a cooling control unit, the dew point temperature using the detected temperature and detected humidity, and providing a dehumidification control signal when condensation is predicted to occur based on the calculated dew point temperature, thereby causing an air conditioning unit to operate in dehumidifying operation mode for the ESS battery.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a block diagram of a chiller operation system for ESS batteries according to an embodiment of the present disclosure;

FIG. 2 is a view conceptually showing a chiller operation system for ESS batteries according to an embodiment of the present disclosure; and

FIGS. 3A and 3B, which are combined at point A, are a flowchart showing an operating method of a chiller operation system for ESS batteries according to an embodiment of the present disclosure.

### DETAILED DESCRIPTION OF THE INVENTION

Advantages and features of embodiments of the present disclosure and methods of achieving them will become clear by referring to the embodiments described in detail below along with the accompanying drawings. However, the present disclosure may be implemented in many different forms and is not limited to the embodiments described below. The embodiments are provided solely to ensure that the disclosure of the present disclosure is complete and to fully inform those skilled in the art of the scope of the invention. The present disclosure is defined only by the scope of the claims. Like reference numerals refer to like elements throughout the specification.

In describing the embodiments of the present disclosure, when it is determined that a detailed description of a related known function or configuration may unnecessarily obscure the subject matter of the present disclosure, the specific description thereof will be omitted. In addition, since the terms described below are defined in consideration of functions in the present disclosure, they may vary according to user, operator intention, custom, and the like. Therefore, the terms should be interpreted based on the contents throughout the specification.

Hereinafter, with reference to the accompanying drawings, embodiments of the present disclosure will be described in detail.

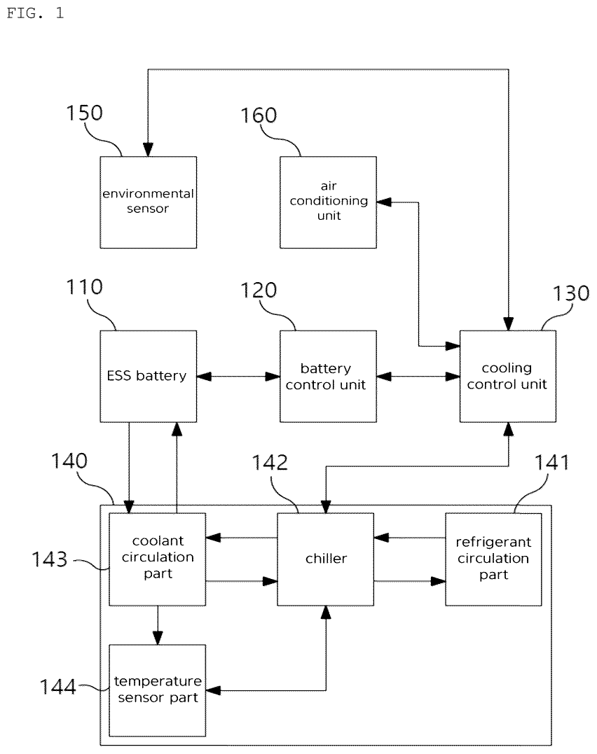

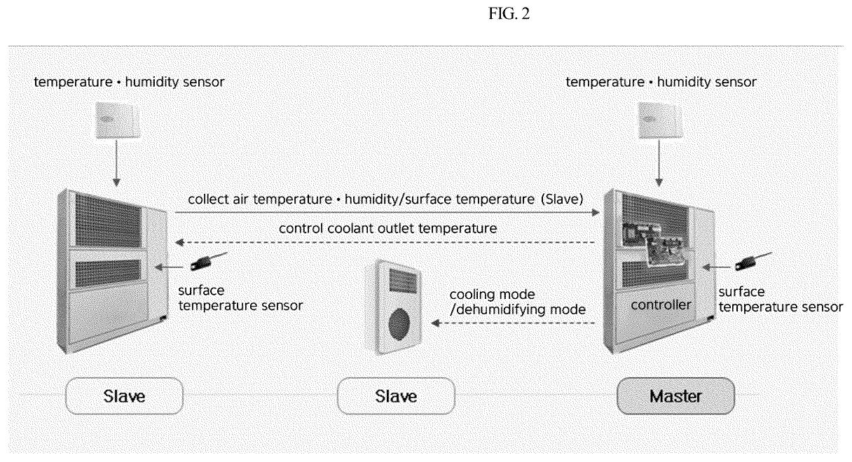

FIG. 1 is a block diagram of a chiller operation system for ESS batteries according to an embodiment of the present disclosure, and FIG. 2 is a view conceptually showing a chiller operation system for ESS batteries according to an embodiment of the present disclosure.

Referring to FIG. 1, a chiller operation system for ESS batteries according to an embodiment of the present disclosure may include an ESS battery 110, a battery control unit 120, a cooling control unit 130, a chiller unit 140, and an air conditioning unit 160.

The ESS battery 110 includes a battery module composed of battery cells, including, for example, lithium-ion batteries, and may be charged or discharged under the control of the battery control unit 120.

The battery control unit 120 is a unit that controls charging and discharging of the ESS battery 110 by including a battery control unit (BCU) that controls the entire ESS battery 110 and a battery control panel (BCP) that controls the inside of the ESS battery 110. The battery control unit 120 may communicate with the cooling control unit 130 and control the charging and discharging of the ESS battery 110.

The battery control unit 120 may provide a cooling start signal to the cooling control unit 130 to cool the ESS battery 110 by means of the chiller unit 140 during charging and discharging of the ESS battery 110.

In addition, when charging and discharging of the ESS battery 110 is completed, the battery control unit 120 may provide a cooling stop signal to the cooling control unit 130 so that the chiller unit 140 operates in stand-by mode.

The cooling control unit 130 communicates with the battery control unit 120 and performs heat management by providing a cooling control signal during charging and discharging of the ESS battery 110. The cooling control unit 130 may calculate dew point temperature on the basis of detected temperature and detected humidity for the condensation occurrence area provided by an environmental sensor 150, and provide a dehumidification control signal to the air conditioning unit 160 when condensation is predicted to occur on the basis of the calculated dew point temperature.

While charging and discharging of the ESS battery 110 is performed by means of the battery control unit 120, the cooling control unit 130 may check whether a cooling start signal is input by communicating with the battery control unit 120 and provide a cooling control signal to the chiller unit 140 when the cooling start signal is input.

When a cooling start signal is not input from the battery control unit 120, the cooling control unit 130 may check whether the preset chiller temperature conditions are satisfied, and may provide a cooling control signal to the chiller unit 140 when the preset chiller temperature conditions are satisfied.

In the process of checking whether the preset chiller temperature conditions are satisfied, the cooling control unit 130 may provide a cooling control signal to the chiller unit 140 when both a first chiller temperature condition and a second chiller temperature condition are met.

That is, the cooling control unit 130 may provide a cooling control signal to the chiller unit 140 when a cooling start signal is input from the battery control unit 120 or the preset chiller temperature conditions are satisfied.

In addition, the cooling control unit 130 may set stand-by mode temperature conditions on the basis of the temperature of chiller inlet water received into the chiller unit 140 and the temperature of chiller outlet water discharged from the chiller unit 140. The preset stand-by mode temperature conditions may be set to compare a temperature change value for a preset time and a preset stand-by mode deviation value when the chiller inlet water temperature exceeds the chiller outlet water temperature.

At this time, the cooling control unit 130 may control the chiller unit 140 to operate according to a preset stand-by mode temperature value and a preset stand-by mode flow rate value as the chiller unit 140 enters stand-by mode.

That is, the cooling control unit 130 may control the chiller unit 140 to switch to the stand-by mode only when a cooling stop signal is input from the battery control unit 120 and the preset stand-by mode temperature conditions are satisfied.

Meanwhile, when the detected temperature and detected humidity are provided from the environmental sensor 150, the cooling control unit 130 may calculate the dew point temperature using the Magnus formula as shown in Equation 1 below.

$$γ ( T , RH ) = ln ( \frac{RH}{100} ) + \frac{bT}{c + T} ; \\ {T}_{dp} = \frac{c γ ( T , RH )}{b - γ ( T , RH )} ; \qquad [ Equation 1 ]$$

In this case, T refers to the detected temperature and RH refers to the detected humidity.

In addition, the cooling control unit 130 may check whether condensation is predicted on the basis of the calculated dew point temperature. When the calculated dew point temperature is within a standard dew point temperature range where condensation occurs (i.e., standard dew point temperature+0.5 degrees or less) and condensation is predicted to occur, the cooling control unit 130 may provide a dehumidification control signal to the air conditioning unit 160 so that the air conditioning unit 160 operates in the dehumidifying operation mode. That is, the cooling control unit 130 may cause the dehumidifying operation to be performed in order to remove moisture inside a container in which the ESS battery 110 is installed.

Meanwhile, while the air conditioning unit 160 is operating in the dehumidifying operation mode, the cooling control unit 130 may check whether the probability of condensation occurring within a preset first time is less than a preset condensation occurrence standard value. When the probability of condensation occurring within the preset first time is less than the preset condensation occurrence standard value, the cooling control unit 130 may re-measure detected temperature and detected humidity for the condensation occurrence area and repeatedly re-perform condensation occurrence prediction based on dew point temperature calculation.

In this case, when the calculated dew point temperature exceeds the standard dew point temperature at which condensation occurs by a preset temperature value (e.g., 1 degree, 2 degrees, etc.), the cooling control unit 130 may determine that the probability of condensation occurring is less than the preset condensation occurrence standard value.

When the probability of condensation occurring within the preset first time (e.g., 1 minute, 2 minutes, etc.) is greater than or equal to the preset condensation occurrence standard value, the cooling control unit 130 may provide a temperature adjustment signal to the chiller unit 140 to adjust the chiller outlet water temperature according to a preset chiller temperature value (e.g., 1 degree, 2 degrees, etc.).

In this case, the cooling control unit 130 may determine that the probability of condensation occurring is greater than the preset condensation occurrence standard value when the calculated dew point temperature is below the standard dew point temperature at which condensation occurs.

In addition, while the chiller unit 140 is operating by adjusting the chiller outlet water temperature, the cooling control unit 130 may check whether the probability of condensation occurring within a preset second time (e.g., 1 minute, 2 minutes, etc.) has reached a level below the preset condensation occurrence standard value. When the probability is greater than the preset condensation occurrence standard value, the cooling control unit 130 may output a condensation occurrence alarm through a separate speaker (not shown). In addition to outputting the alarm through the speaker, an alarm message may also be displayed on a display device of an administrator terminal linked to the cooling control unit 130.

Meanwhile, when the probability of condensation occurring within the preset second time has reached a level below the preset condensation occurrence standard value, the cooling control unit 130 may control the chiller unit 140 to return the chiller outlet water temperature to the original chiller outlet water temperature, and may provide a low load operation signal to the air conditioning unit 160 to operate the air conditioning unit 160 according to a preset low load value.

The chiller unit 140 is a unit that cools the ESS battery 110 according to a cooling control signal provided from the cooling control unit 130 during charging and discharging of the ESS battery 110. The chiller unit 140 may include a refrigerant circulation part 141, a chiller 142, a coolant circulation part 143, and a temperature sensor part 144.

In this case, the refrigerant circulation part 141 includes a compressor, a condenser, an expander, an evaporator, etc., and may circulate a refrigerant through the interior of the chiller 142.

The chiller 142 may be controlled to circulate a coolant at a preset temperature to the ESS battery 110 by heat exchange between the refrigerant circulating by the refrigerant circulation part 141 and the coolant circulating by the coolant circulation part 143.

In addition, heat is exchanged between a coolant circulated through the interior of the chiller 142 by means of the coolant circulation part 143 and a refrigerant circulated by means of the refrigerant circulation part 141, and the coolant may be circulated through the inside of a metal plate provided at the bottom of each battery module provided in the ESS battery 110 and through the inside of the chiller 142.

Due to the coolant circulating through an internal flow path of the metal plate, the temperature of each battery module provided in the ESS battery 110 may be maintained at the target temperature.

Meanwhile, the temperature sensor part 144 may be provided on a coolant circulation line inside the chiller 142. The temperature sensor part 144 may measure a temperature Ti of the chiller outlet water discharged from the inside of the chiller 142 to the metal plate through the coolant circulation part 143 and a temperature Ti of the chiller inlet water that circulates through the metal plate and enters the interior of the chiller 142 through the coolant circulation part 143, and provide the measured temperatures to the cooling control unit 130.

When a stand-by mode conversion signal is provided from the cooling control unit 130, the chiller unit 140 may switch to the stand-by mode and operate according to the preset stand-by mode temperature value and the preset stand-by mode flow rate value befitted the stand-by mode.

In addition, when a temperature adjustment signal is provided from the cooling control unit 130, the chiller unit 140 may discharge and circulate a coolant by raising the chiller outlet water temperature according to the preset chiller temperature value (e.g., 1 degree, 2 degrees, etc.).

The environmental sensor 150 includes, for example, a plurality of temperature sensors, a plurality of humidity sensors, etc., and may be provided outside the ESS battery 110 to measure the detected temperature and detected humidity in an area where condensation occurs. After installing the plurality of temperature sensors in the condensation occurrence area including the surface, front, and surroundings of a loading box (or loading compartment) where the ESS battery 110 is installed, and parts vulnerable to condensation, installing a temperature sensor to measure air temperature and a humidity sensor to measure air humidity, and measuring detected temperature and detected humidity, including the temperature for the condensation occurrence area, air temperature, and air humidity at multiple locations using the plurality of temperature sensors and the plurality of humidity sensors, the measured values may be provided to the cooling control unit 130.

The air conditioning unit 160 may operate in the dehumidifying operation mode for the ESS battery 110 according to a dehumidification control signal provided from the cooling control unit 130. The air conditioning unit 160 may improve the maintenance efficiency for the ESS battery 110 by including, for example, a cooling device, a dehumidifying device, and a heating device to perform operations such as cooling, dehumidifying, heating, etc. for the loading box (or loading compartment) equipped with the ESS battery 110 and the surroundings of the loading box (or loading compartment).

The air conditioning unit 160 may operate in 100% dehumidifying operation according to the dehumidifying operation mode when a dehumidification control signal is provided from the cooling control unit 130.

In addition, the air conditioning unit 160 may be operated in low load operation according to a preset low load value when a low load operation signal is provided from the cooling control unit 130.

Therefore, according to the embodiment of the present disclosure, condensation in ESS batteries may be prevented and active maintenance of the ESS batteries may be possible by measuring detected temperature and detected humidity in an area where condensation occurs using an environmental sensor installed on the outside of an ESS battery, calculating, by the cooling control unit, the dew point temperature using the detected temperature and detected humidity, and providing a dehumidification control signal when condensation is predicted to occur based on the calculated dew point temperature, thereby causing the air conditioning unit to operate in dehumidifying operation mode for the ESS battery.

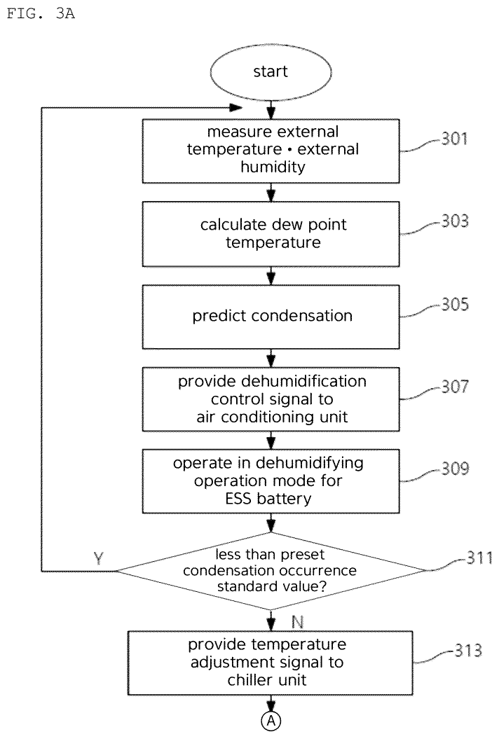

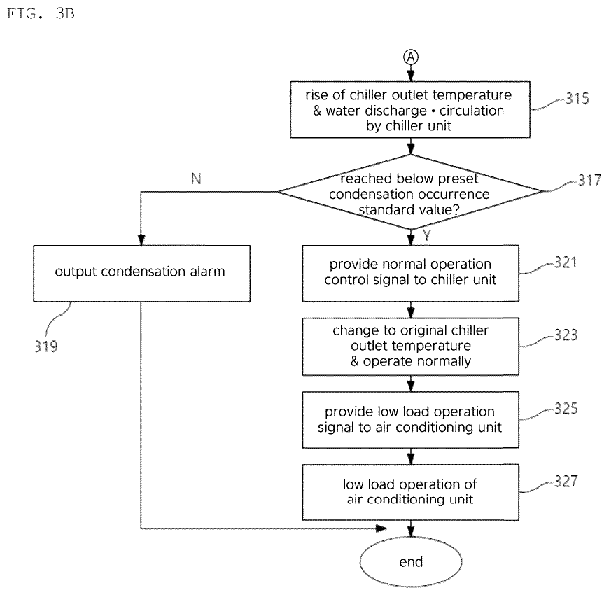

FIGS. 3A and 3B, which are combined at point A, are a flowchart showing an operating method of a chiller operation system for ESS batteries according to an embodiment of the present disclosure.

Referring to FIGS. 3A and 3B, detected temperature and detected humidity of a condensation occurrence area may be measured (step 301) by means of an environmental sensor 150 provided outside an ESS battery 110.

In this case, after installing a plurality of temperature sensors in the condensation occurrence area including the surface, front, and surroundings of a loading box (or loading compartment) where the ESS battery 110 is installed, and parts vulnerable to condensation, installing a temperature sensor to measure air temperature and a humidity sensor to measure air humidity, and measuring detected temperature and detected humidity, including the temperature for the condensation occurrence area, air temperature, and air humidity at multiple locations by the environmental sensor 150 using the plurality of temperature sensors and a plurality of humidity sensors, the measured values may be provided to a cooling control unit 130.

Then, the cooling control unit 130 may calculate (step 303) the dew point temperature using the detected temperature and detected humidity for the condensation occurrence area.

In step 320 of calculating the dew point temperature, the dew point temperature may be calculated using the Magnus formula as shown in Equation 1 above.

Thereafter, the cooling control unit 130 may predict (step 305) an occurrence of condensation based on the calculated dew point temperature.

At this time, when the calculated dew point temperature is within a standard dew point temperature range where condensation occurs (i.e., standard dew point temperature+0.5 degrees or less), the cooling control unit 130 may determine that condensation is expected to occur.

Thereafter, when condensation is expected to occur, the cooling control unit 130 may provide (step 307) a dehumidification control signal to an air conditioning unit 160 so that the air conditioning unit 160 operates in a dehumidifying operation mode.

When the dehumidification control signal is provided from the cooling control unit 130, the air conditioning unit 160 may operate (step 309) in dehumidifying operation for the ESS battery 110 in accordance with the dehumidifying operation mode. That is, the air conditioning unit 160 may perform a dehumidifying operation to remove moisture inside a container where the ESS battery 110 is installed.

In addition, while the air conditioning unit 160 is operating in the dehumidifying operation mode, the cooling control unit 130 may check (step 311) whether the probability of condensation occurring within a preset first time is less than a preset condensation occurrence standard value.

At this time, when the calculated dew point temperature exceeds the standard dew point temperature at which condensation occurs by a preset temperature value (e.g., 1 degree, 2 degrees, etc.), the cooling control unit 130 may determine that the probability of condensation occurring is less than the preset condensation occurrence standard value.

As a result of the checking in step 311, when the probability of condensation occurring within the preset first time is less than the preset condensation occurrence standard value, the cooling control unit 130 may repeatedly re-perform the process from the step (301) of re-measuring detected temperature and detected humidity for the condensation occurrence area to the step (305) of predicting condensation by calculating dew point temperature and the step (311) of checking whether the probability of condensation occurring is less than the preset condensation occurrence standard value.

On the other hand, as a result of the checking in step 311, when the probability of condensation occurring within the preset first time (e.g., 1 minute, 2 minutes, etc.) is greater than the preset condensation occurrence standard value, the cooling control unit 130 may provide (step 313) a temperature adjustment signal to a chiller unit 140 to adjust the chiller outlet water temperature according to a preset chiller temperature value (e.g., 1 degree, 2 degrees, etc.).

In this case, when the calculated dew point temperature is below the standard dew point temperature at which condensation occurs, the cooling control unit 130 may determine that the probability of condensation occurring is greater than the preset condensation occurrence standard value.

Accordingly, when the temperature adjustment signal is provided from the cooling control unit 130, the chiller unit 140 may discharge and circulate (step 315) a coolant by raising the chiller outlet water temperature according to a preset chiller temperature value (e.g., 1 degree, 2 degrees, etc.). That is, when the temperature adjustment signal is provided from the cooling control unit 130, the chiller unit 140 may discharge and circulate the coolant according to the preset chiller temperature value and a preset chiller flow rate value.

Thereafter, while the chiller unit 140 is operating by adjusting the chiller outlet water temperature, the cooling control unit 130 may check (step 317) whether the probability of condensation occurring within a preset second time (e.g., 1 minute, 2 minutes, etc.) has reached a level below the preset condensation occurrence standard value.

As a result of the checking in step 317, when the probability of condensation occurring within the preset second time has reached below the preset condensation occurrence standard value, the cooling control unit 130 may be controlled to output (step 319) a condensation occurrence alarm through a separate speaker (not shown).

In this case, in addition to outputting the alarm through the speaker, the cooling control unit 130 may also display an alarm message on a display device of an administrator terminal linked to the cooling control unit 130.

On the other hand, as a result of the checking in step 317, when the probability of condensation occurring within the preset second time is greater than the preset condensation occurrence standard value, the cooling control unit 130 may provide (step 321) a normal operation control signal to the chiller unit 140 so that the chiller outlet water temperature may be normalized to the original chiller outlet water temperature.

Accordingly, the chiller unit 140 may be operated (step 323) in normal operation by changing the chiller outlet water temperature to the original chiller outlet water temperature and discharging water normally.

Thereafter, the cooling control unit 130 may provide (step 325) a low load operation signal to the air conditioning unit 160 to operate the air conditioning unit 160 according to a preset low load value.

Subsequently, when the low load operation signal is provided from the cooling control unit 130, the air conditioning unit 160 may be operated (step 327) in low load operation in accordance with a preset low load value.

Therefore, according to another embodiment of the present disclosure, condensation in ESS batteries may be prevented and active maintenance of the ESS batteries may be possible by measuring detected temperature and detected humidity in an area where condensation occurs using an environmental sensor installed on the outside of an ESS battery, calculating, by the cooling control unit, the dew point temperature using the detected temperature and detected humidity, and providing a dehumidification control signal when condensation is predicted to occur based on the calculated dew point temperature, thereby causing the air conditioning unit to operate in dehumidifying operation mode for the ESS battery.

Although a variety of embodiments of the present disclosure have been presented and described in detail above, the scope of the present disclosure is not limited thereto, and those skilled in the art to which the present disclosure pertains will easily understand that various substitutions, modifications, and changes can be made without departing from the technical spirit of the present disclosure.

What is claimed is:

1. A chiller operation system for ESS batteries, the system comprising:
an ESS battery;
a battery control unit configured to control charging and discharging of the ESS battery;
a chiller unit configured to cool the ESS battery according to a cooling control signal during charging and discharging of the ESS battery;
an environmental sensor provided outside the ESS battery to measure detected temperature and detected humidity in a condensation occurrence area;
a cooling control unit configured to communicate with the battery control unit, perform heat management by providing the cooling control signal during charging and discharging of the ESS battery, calculate dew point temperature using the detected temperature and the detected humidity, and provide a dehumidification control signal when condensation is predicted to occur on the basis of the calculated dew point temperature; and
an air conditioning unit configured to operate in dehumidifying operation mode for the ESS battery according to the dehumidification control signal.

2. The system of claim 1, wherein the cooling control unit calculates the dew point temperature using Magnus formula.

3. The system of claim 2, wherein while the air conditioning unit is operating in the dehumidifying operation mode, the cooling control unit checks whether a probability of condensation occurring within a preset first time is less than a preset condensation occurrence standard value and provides a temperature adjustment signal to the chiller unit to adjust chiller outlet water temperature when the probability is greater than the preset condensation occurrence standard value.

4. The system of claim 3, wherein while the chiller unit is operating with the chiller outlet water temperature adjusted, the cooling control unit checks whether a probability of condensation occurring within a preset second time has reached a level below the preset condensation occurrence standard value, and outputs an alarm when the probability is greater than the preset condensation occurrence standard value.

5. An operating method of a chiller operation system for ESS batteries, the method comprising:
measuring detected temperature and detected humidity in a condensation occurrence area using an environmental sensor provided outside an ESS battery;
calculating, by a cooling control unit, dew point temperature using the detected temperature and the detected humidity;
checking, by the cooling control unit, whether condensation is predicted on the basis of the calculated dew point temperature;
providing, by the cooling control unit, a dehumidification control signal when the condensation is predicted to occur; and
operating an air conditioning unit in dehumidifying operation mode for the ESS battery according to the dehumidification control signal provided from the cooling control unit.

6. The method of claim 5, wherein in the calculating dew point temperature, the dew point temperature is calculated using Magnus formula.

7. The method of claim 6, further comprising:
checking, by the cooling control unit, whether a probability of condensation occurring within a preset first time is less than a preset condensation occurrence standard value while the air conditioning unit is operating in the dehumidifying operation mode; and
providing, by the cooling control unit, a temperature adjustment signal to the chiller unit to adjust chiller outlet water temperature when the probability is greater than the preset condensation occurrence standard value.

8. The method of claim 7, further comprising:
checking, by the cooling control unit, whether a probability of condensation occurring within a preset second time has reached a level below the preset condensation occurrence standard value while the chiller unit is operating with the chiller outlet water temperature adjusted; and
outputting an alarm when the probability is greater than the preset condensation occurrence standard value.
